(19) United States
(12) Patent Application Publication
(10) Pub. No.: US 2014/0367292 A1
(43) Pub. Date: Dec. 18, 2014

(54) TRASH CART SMART LID

(71) Applicant: National Cart Marketing, LLC, New Buffalo, MI (US)

(72) Inventors: Philip H. Bonello, New Buffalo, MI (US); David Workman, New Buffalo, MI (US); John Guenther, Chicago, IL (US)

(21) Appl. No.: 14/308,652

(22) Filed: Jun. 18, 2014

Related U.S. Application Data
(60) Provisional application No. 61/836,149, filed on Jun. 18, 2013.
(60) Provisional application No. 61/844,174, filed on Jul. 9, 2013.

(51) Int. Cl. B65F 1/14; G09F 23/00

(52) U.S. Cl. CPC B65F 1/14; B65F 1/1473; B65F 1/1646; G09F 23/00; B65F 2001/1653
USPC 206/459.1; 220/212; 220/810

(57) ABSTRACT

A trash cart lid comprising a body including four edges, wherein the four edges define a perimeter of the body; and at least one flange connected to the body, wherein the flange shares at least a portion of an edge of the body; wherein each flange includes an advertising receiving space. In addition, the lid may provide one or more modules that communicate information about the status of the smart lid and user interactions with the trash cart to a remote server.

### CROSS-REFERENCE TO RELATED APPLICATIONS

This application incorporates by reference and claims the benefit of priority to U.S. Provisional Patent Application No. 61/836,149 filed Jun. 18, 2013, and U.S. Provisional Patent Application No. 61/844,174 filed Jul. 9, 2013.

### BACKGROUND OF THE INVENTION

The present invention is directed to a lid to a trash cart, and in particular to a lid for providing advertising and related services to consumers near the home or office.

Trash carts for homes and businesses are well known in the art. Trash carts have a container body, and in some implementations, wheels may be provided at the lower corner of the container body. Most trash carts have a lid that is affixed to the container that can be opened or closed. To prevent animals from gaining access to the garbage carts or to prevent the spilling of contents, various mechanisms may be used to lock the lid in the closed position.

Trash carts are often owned by cities that provide the carts near consumer residences and businesses to provide trash related services, such as pickup, recycling, etc. Due to their proximity to the home and daily use, trash carts are one of the most frequently used and most frequently encountered services provided by municipalities. However, unlike other municipal services, for example, buses, there has been poor utilization of trash carts for the provisioning of advertising and city services. There are numerous opportunities to capitalize on this under-utilization given an appropriate platform. Thus, there is a need to provide a platform through which access to the consumer provided by trash carts may be monetized.

Accordingly, there is a need for lids for trash carts that leverage the routine and frequent interaction by consumers with trash carts to provide advertising, promotional products, wireless communication, and other services to consumers near the home, as described herein.

### BRIEF SUMMARY OF THE INVENTION

To meet the needs described above and others, the present disclosure provides smart lids for trash carts that leverage the routine and frequent interaction by consumers with trash carts to provide advertising, promotional products, wireless communication, and other services to consumers near the home. The present subject matter may be particularly valuable in that it addresses a point of frequent exposure to users that is currently under utilized. The smart lid may be used as a replacement for the existing lid on commercially available trash carts. Advertising and other services may be provided on the smart lid to permit users to interact with the advertising when taking out their trash. Trash haulers can manage the lids when disposing the trash contents. Since trash carts are frequently emptied, there are frequent opportunities for updating advertising or associated services by field technicians.

The smart lid may be mounted on a standard garbage or recycling cart. The smart lid may be four-sided and include surfaces having display panels for advertising. The display panels may be molded into the surface of the smart lid. For example, the display panels may be J-channels that may accommodate either printed placards or electronic displays. The advertising may be provided as placards or as digital screens, such as LED, OLED, e-ink or other dynamic screens. In a preferred embodiment, the overall dimension of each display panel may be 18″W×5″H. Each display surface may include a border for securing panels. The advertisements may be coordinated to create a “wrap-around” effect of a single advertisement displayed across the multiple display panels. Alternatively, each display panel may include a distinct advertisement.

In an embodiment, the smart lid is a dual-level lid including a lower level of display panels that wrap around the rim of the smart cart opening and an upper level of display panels that are elevated above the lower level to provide additional display surfaces. The lower level of the smart lid may include flanges including display panels. Advertising may be placed in any and/or all of the display surfaces. For example, in an embodiment, two levels of advertising are displayed on the front surface and the side surfaces of the smart lid, thus including at least six panes of display surfaces. A 2-UP display panel (i.e., two pages or two advertisements on a single display panel) may also be provided at the rear of the lid between the mounting arms.

In another embodiment, the smart lid may include a single level of display panels. The display panels may form a skirt of panels covering the rim of the trash cart. In a contemplated embodiment, three display panels are provided, one on the front and one on each side. In some embodiments of a smart lid including a single level, the upper surface of the smart lid covering the trash cart may include further advertising displayed flat on the surface.

In order to provide a surface for the advertising, handles may be provided at the forward corners leaving the front surface available for a display panel. The handles preferably provide sufficient opening and clearance to receive a user's hand therein. The user may utilize the handles to lift the smart lid off the body of the trash cart to place trash within the cart or to access the trash during pickup.

The smart lid may further include a raised lateral rib for attaching an identification marker. In an embodiment, the identification marker may be an RFID chip uniquely identifying the smart lid. Additionally, the smart lid may include a slot for collecting smaller waste objects without requiring the opening of the lid. The smart lid may be configured to be easy to install, replace and serviced by field technicians by using standard lid attachment mechanisms.

The smart lids may come in different lid configurations. For example, the lid may be provided to fit various standard recycling cart sizes, such as small (5″W×4″H), medium (11″W×4″H), and large (17″W×4″H) sizes.

The smart lid may be made of substantially rigid materials that are weather proof under extreme weather conditions such as temperatures in the range of −40 F Degrees to 120 F Degrees. The smart lid may be further constructed of materials that are UV resistant to prevent fading. In an embodiment, the body of the smart lid may be formed of a plastic material such as HDPE, via an injection molding process, or may be made of other materials and by other processes as will be recognized by those skilled in the art. The smart lid may be constructed from a plurality of panels made with sufficiently rigid material to replace the existing lid on a standard recycling cart. The smart lid may further include raised lateral rib for attaching a branding.

The smart lid may include a lid attachment mechanism for joining the smart lid to the cart in a secure fashion. The lid attachment mechanism may be adjustable to fit a wide variety of trash and recycling carts. The lid attachment mechanism may include mounting arms including a hinge. The hinge may include metal materials made of aluminum alloy or non-ferrous composite to prevent corrosion. In a preferred embodiment, the hinge is a two-part hinge wherein the first part of a two-part hinge is attached to the mounting arms. In the preferred embodiment, the second part of the two-part hinge may be chosen from a plurality of configurations corresponding to various trash and recycling cart hinge pins. For example, a second part of the two-part hinge may be adapted to encompass a hinge pin of a particular diameter. In an embodiment, the mounting arms may be laterally adjustable to fit various handle configurations to be secured between structural elements of the hinge pin.

In another embodiment, the smart lid may include adjustable hinge caps that may be independently adjusted to secure the smart lid to various trash and recycling cart configurations. The hinge caps may be adapted to attach to the smart lid at along an attachment face of the smart lid. The attachment face may be a boss face having various attachment points, such as bolt holes, that may be placed to enable the trash cart lid to attach to popular models of trash and recycling carts. The hinge caps may include two or more parts adapted to encompass the hinge pin or cart handle to attach the smart lid to a cart when installed. For example, the hinge caps may include two parts having opposing grooves that may be joined to form a passage encompassing the hinge pin or cart handle. Further, to permit further attachment configurations, the attachment face may include a slot to accommodate the hinge pin or cart handle. The hinge pin or cart handle may be secured in the slot by attaching the hinge caps or hinge brackets.

Placards may be made from weather resistant materials that will accept black and white or up to four-color printing. Placards may preferably be constructed to withstand usage in an outdoor context for up to 180 days. Placards are easy to install, replace and serviced by field technicians. In a preferred embodiment, the placards are configured to be readable at close range when in use (both when rolling the cart and when opening and closing the lid on the cart). The placards may include QR codes imprinted on each placard that may be easily scanned by a QR code reader, such as a mobile device, to provide additional information or promotions.

The smart lid may accommodate sampling programs to provide consumers with promotional samples. It is contemplated that when consumers are taking out the trash they may be especially primed to receive promotional samples for hygiene and sanitary related products, such as, hand sanitizer, dishwashing detergent, etc. Promotional samples may be provided via a dispenser integrated into the smart lid. The dispenser may be configured to provide access to a service person, such as a trash hauler, to refill or replace the dispenser contents.

The smart lid may include electronics to provide additional services, manage electronic advertising, and to monitor the smart cart. For example, in an embodiment, the smart lid may include a controller, wireless communications module, sensors, and battery. The wireless communication module may act as a repeater for cellular communications. Alternatively, or in addition, the wireless communications module may provide a wireless access point for nearby consumers, for example, a Wi-Fi access point.

The sensors may be used to communicate information concerning the quantity and the composition of the trash cart for analytic review. The sensors may include chemical sensors to detect trash cart contents based on the molecular composition of the trash. For example, the chemical sensors may be an electronic nose, chemosensor, etc. The smart lid may relay sensor readings of the contents of the trash cart to trash haulers to permit actions, such as early pickup of trash in response to the detection of contents likely to attract pests, such as rodents and insects. For example, the sensors may further detect how full the cart is. The sensors may further detect when the lid is opened or closed. When the lid is opened or closed, the trash cart may record an impression. The recorded impressions may be transmitted to servers to collect the advertising results of the advertising provided. Further, when sensors detect an open lid, digital advertising may be changed, for example, a video may be played, or a new advertisement may be displayed.

The one or more sensors in the smart lid that monitor, record, and/or communicate information regarding a user's interaction with the smart lid may be used to gather a multitude of data points including when a user interacts with the trash cart, how often a user interacts with the trash cart, and use that information to develop individual or aggregated user profiles. Such information can be used to provide more directed communications and advertisements, support the value of the interaction with the users, etc.

In an embodiment, a trash cart lid includes a body including four edges, wherein the four edges define a perimeter of the body; and at least one flange connected to the body, wherein the flange shares at least a portion of an edge of the body; wherein each flange includes an advertising receiving space. In some embodiments, the advertising receiving space includes a slot to receive an advertisement placard. In other embodiments, the advertising receiving space is an electronic display.

In some embodiments, the body includes a top surface and at least two advertising receiving spaces, wherein the advertising receiving space extend vertically from an edge of the body to the top surface. Additionally, in some embodiments, the body includes a top surface and four side surfaces, wherein each side surface extends from an edge of the body to the top surface, wherein at least three side surfaces include an advertising receiving space. Further in some embodiments, the four edges are each separated by a corner, wherein the lid further includes at least one corner handle connected to at least one corner.

In some embodiments, the trash cart lid is hingedly attached to a trash cart having a rim defining an opening into a cavity of the trash cart, each flange extends below a plane defined by the rim of the trash cart when the trash cart lid covers the opening of the trash cart. Additionally, in some embodiments, the trash cart lid includes three flanges, wherein each flange is attached to a separate edge of the body. Further, in some embodiments, the trash cart lid further includes: an attachment face connected to at least one edge of the body of the lid; and an adaptor configured to attach the trash cart lid to a trash cart, wherein the adaptor includes at least two hinge caps removably attached to the attachment face, wherein each hinge cap includes a first groove and a second groove, wherein the first groove and the second grove define an aperture to receive a cart handle of a trash cart.

In an embodiment, a waste container lid includes: a body including four edges, wherein the four edges define a perimeter of the body; at least one flange extending from the body, wherein the flange shares at least a portion of an edge of the body, wherein each flange includes an advertising receiving space, wherein at least one advertising receiving space includes a display panel; a controller in communication with the display panel; and a memory coupled to the controller, wherein the memory is configured to store program instructions executable by the controller, wherein in response to executing the program instructions, the controller is configured to: select an advertisement from a database in communication with the controller, wherein the database includes a plurality of advertisements; and display the selected advertisement on at least one display panel.

In some embodiments, the waste container lid further includes at least one sensor in communication with the controller, wherein the controller is further configured to: receive data from the at least one sensor, and select an advertisement from the database, wherein the selected advertisement is based on the received data.

In some embodiments, the trash cart lid further includes at least one motion sensor in communication with the controller, wherein the controller is further configured to: receive data from the motion sensor indicating movement of the body, wherein the received data is associated with a unique trash cart identifier; access a database including the unique trash cart identifier and associated displayed first advertisement; select a second advertisement from the database, wherein the first advertisement and second advertisement are different; and display the second advertisement on the display panel.

In some embodiments, the body includes a top surface and four side surfaces, wherein each side surface extends from an edge of the body to the top surface, wherein at least three side surfaces include an advertising receiving space. Additionally, in some embodiments, the four edges are each separated by a corner, wherein the lid further includes at least one corner handle connected to at least one corner.

In some embodiments, the trash cart lid is hingedly attached to a trash cart having a rim defining an opening into a cavity of the trash cart, each flange extends below a plane defined by the rim of the trash cart when the trash cart lid covers the opening of the trash cart. Additionally, in some embodiments, the trash cart lid includes three flanges, wherein each flange is attached to a separate edge of the body.

In some embodiments, the trash cart lid of claim 10 further includes: an attachment face connected to at least one edge of the body of the lid; and an adaptor configured to attach the trash cart lid to a trash cart, wherein the adaptor includes at least two hinge caps removably attached to the attachment face, wherein each hinge cap includes a first groove and a second groove, wherein the first groove and the second grove define an aperture to receive a cart handle of a trash cart.

In some embodiments, the trash cart lid further includes at least one proximity sensor in communication with the controller, wherein the controller is further configured to: receive data from the proximity sensor, wherein the received data includes a trash cart identifier and an associated waste height of waste within the trash cart associated with the trash cart identifier; store the received data in the database, wherein the database includes a plurality of trash cart identifiers and associated waste heights; upon receiving data indicating the waste height matches a predetermined waste height threshold, communicate the waste height data to a remote server in communication with a trash collection system. Additionally, in some embodiments, upon receiving data indicating the waste height matches the predetermined waste height threshold, the controller is configured to display a message on the display panel, wherein the message indicates the trash cart is full.

An object of the invention is to provide a platform through which consumer interaction with trash carts may be monetized.

An advantage of the invention is that it provides smart lids for trash carts that provide advertising.

Another advantage of the invention is that it provides smart lids for trash carts that provide promotional products.

A further advantage of the invention is that it provides smart lids for trash carts that provide wireless communications, and other services, to consumers near the home.

Yet another advantage of the invention is that it provides smart lids for trash carts that include one or more sensors in the lid of trash cart that record and communicate information regarding a user's interaction with the smart lid.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a perspective view of an example of a smart lid mounted on a standard garbage or recycling cart.

FIG. 2a is top view of the smart lid of FIG. 1.

FIG. 2b is a side view of the smart lid of FIG. 1.

FIG. 2c is a top perspective view of the smart lid of FIG. 1.

FIG. 3 is a perspective view of another example of a smart lid including a single level of display panels.

FIG. 4a is a rear perspective view of an example of a smart lid including adjustable hinge caps for securing the lid to various cart configurations.

FIG. 4b is a detail view of the attachment face of the smart lid of FIG. 4a.

FIG. 5a is a top view of a further example of a smart lid including a sampling program dispenser, a lid attachment mechanism, and electronic displays and sensors.

FIG. 5b is a side view of the smart lid of FIG. 5a illustrating the dispenser and electronics of the electronic displays and sensors.

FIG. 5c is a detail view of the lid attachment mechanism of the smart lid of FIG. 5a.

FIG. 6 is a block diagram illustrating the electronics of the smart lid of FIGS. 5a-5c.

### DETAILED DESCRIPTION OF THE INVENTION

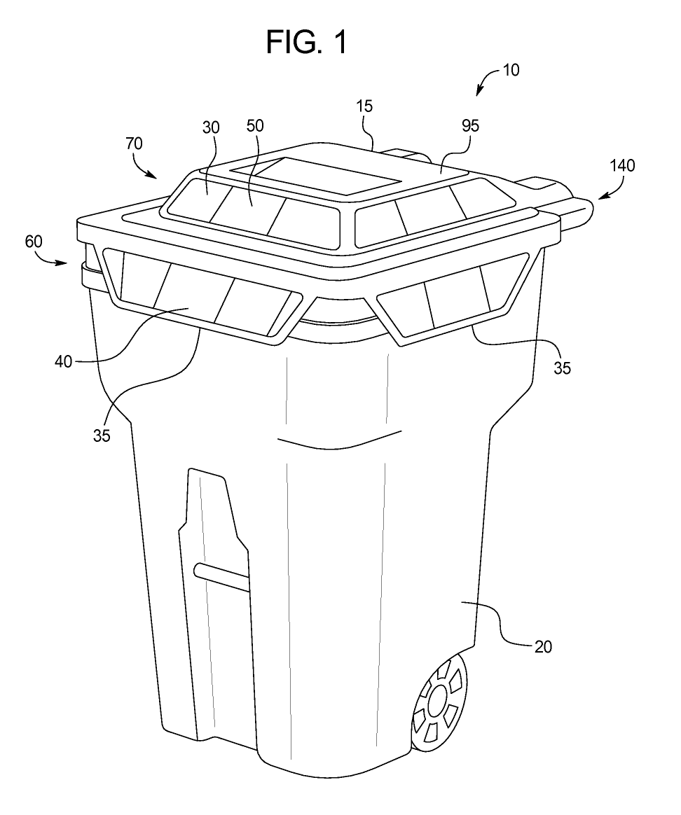

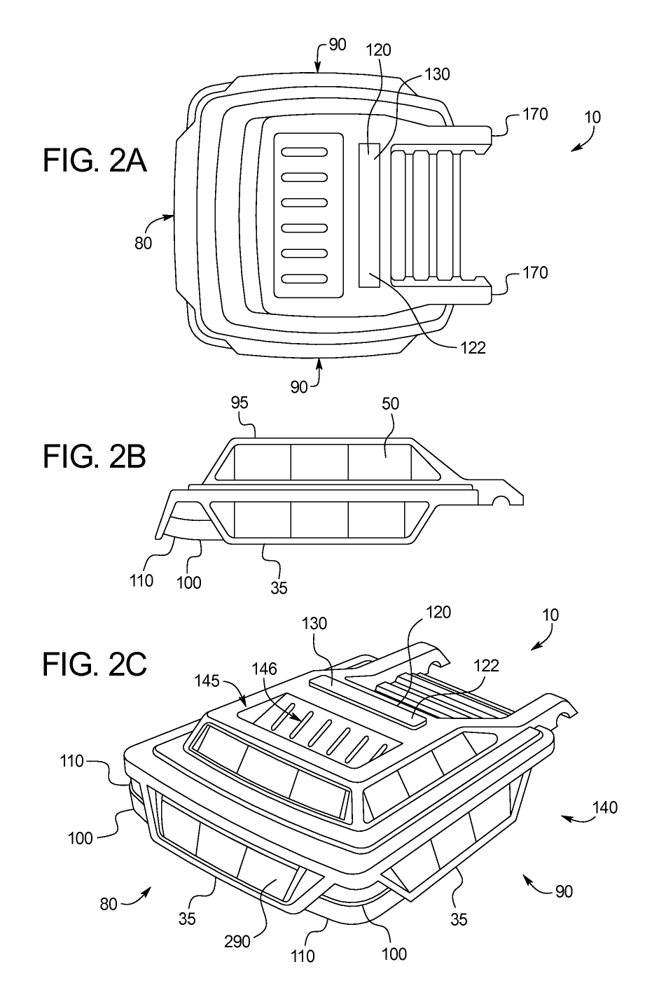

FIG. 1 illustrates an example of a smart lid 10 mounted on a standard garbage or recycling cart 20 (trash cart 20). FIGS. 2a-2c illustrate various additional views of the smart lid 10 of FIG. 1. The smart lid 10 may be four-sided with one or more flanges 35 including advertising receiving spaces 30 supporting display panels 40 for advertising. The advertising receiving spaces 30 may be molded into the body 140 of the smart lid 10. For example, the advertising receiving spaces 30 may be J-channels that may accommodate and support the display of advertising 50. The advertising 50 may be provided as one or more display panels 40. Non-limiting examples of display panels 40 include placards 290 and digital display panels 360. Digital display panels 360 may be any form of digital display, including LED, OLED, e-ink, or other dynamic screens, which may display images or videos. In a preferred embodiment, the overall dimension of each display panel 40 may be 18″W×5″H. Each advertising receiving space 30 may include a border overlapping the display panels 40 to provide structure that assists in securing the display panels 40 within the advertising receiving spaces 30. The advertising 50 may be coordinated to create a “wrap-around” effect of a single advertisement 50 displayed across the multiple display panels 40. Alternatively, each display panel 40 may include a distinct advertisement 50.

In an embodiment, the smart lid 10 is a dual-level smart lid 10 including a lower level 60 of flanges 35 that wrap around the rim of the trash cart 20 and an upper level 70 of display panels 40 that are elevated above the lower level 60 to provide additional display surfaces. The lower level 60 of the smart lid 10 may include flanges 35 including display panels 40 in multiple advertising receiving spaces 30. Naturally, advertising 50 may be placed in any or all of the advertising receiving spaces 30. For example, in an embodiment, two levels of advertising 50 are displayed on the front surface 80 and the side surfaces 90 of the smart lid 10, thus including at least six panes of display panels 40. A display panel 40 may also be provided at the rear 85 of the smart lid 10 between the mounting arms 170.

In order to provide advertising receiving spaces 30 for the advertising 50, handles 100 may be provided at the forward corners 110 leaving the front surface 80 available for a display panel 40. The handles 100 preferably provide sufficient opening and clearance to receive a user's hand therein. A user may utilize the handles 100 to lift the smart lid 10 off the body 140 of the trash cart 20 to place trash within the cart 20 or to access the trash during pickup.

The smart lid 10 may further include a raised lateral rib 120 for attaching an identification marker 130. In an embodiment, the identification marker 130 may be an RFID chip 122 uniquely identifying the smart lid 10. Alternatively, or additionally, the raised lateral rib 120 may be used for attaching a branding plate 150. It is understood that the RFID chip 122, the branding plate 150, and other similar elements may be otherwise located in various portions of the smart lid 10. Additionally, the smart lid 10 may include a collection slot 145 for collecting smaller waste objects without requiring the opening of the smart lid 10. The slot 145 may include a slot flap 146 that moves between an open and closed position to selectively open and close the slot 145. As shown in FIGS. 2a-2c, the slot flap 146 may be a ribbed construction for additional strength.

The smart lids 10 may come in different lid configurations. For example, the smart lid 10 may be provided to fit various standard recycling cart sizes, such as small (5″W×4″H), medium (11″W×4″H), and large (17″W×4″H) sizes.

The smart lid 10 may be made of substantially rigid materials that are weather proof under extreme weather conditions such as temperatures in the range of −40 F degrees to 120 F degrees. The smart lid 10 may be further constructed of materials that are UV resistant to prevent fading. In an embodiment, the body 140 of the smart lid 10 may be formed of a plastic material such as HDPE, via an injection molding process, or may be made of other materials and by other processes as will be recognized by those skilled in the art. The smart lid 10 may be constructed from a plurality of pieces, each made with sufficiently rigid material to replace the existing lid on a standard trash cart 20.

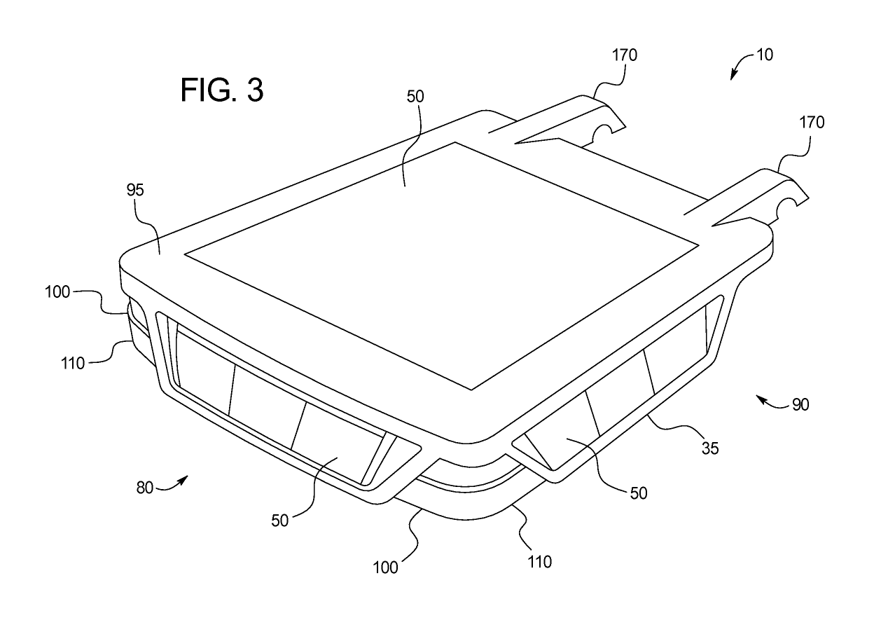

In another embodiment, shown in FIG. 3, the smart lid 10 may include a single lower level 60 of display panels 40 on flanges 35. As shown, the flanges 35 may form a skirt for covering the rim of the cart 20. In a contemplated embodiment, three flanges 35 are provided, one on the front surface 80 and one on each side surface 90. In some embodiments of a smart lid 10 including a single level, the upper surface 95 of the smart lid 10 may include further advertising 50 displayed flat on the upper surface 95.

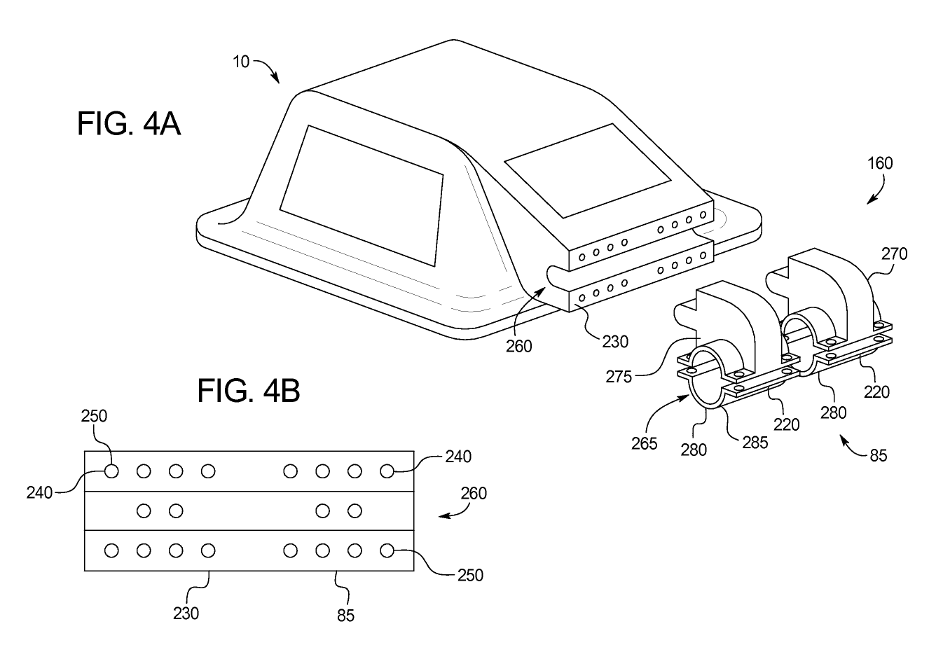

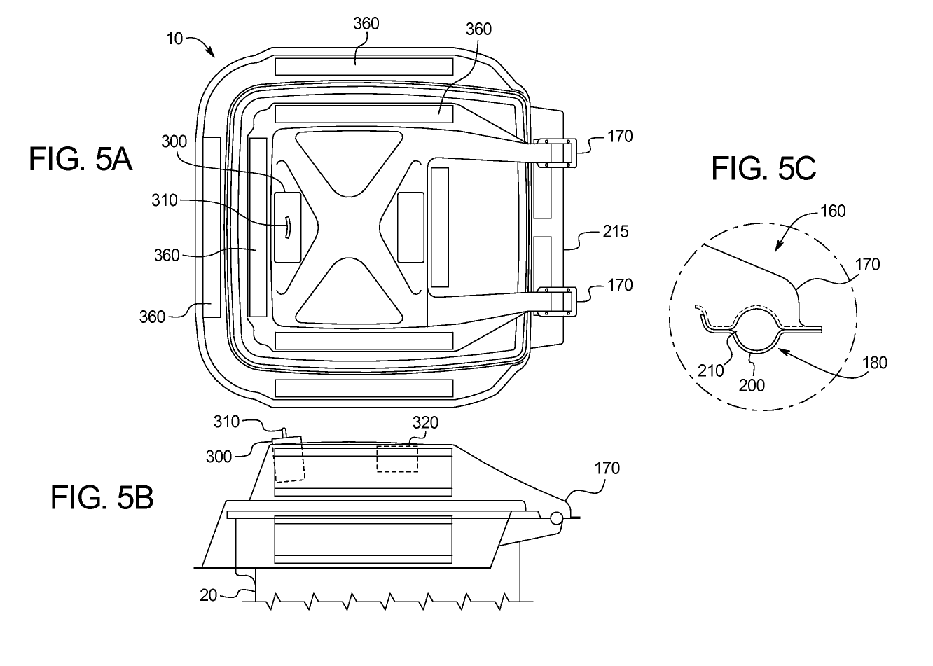

As shown in FIGS. 4a-4b and 5a-5c, the smart lid 10 may include a lid attachment mechanism 160 for securing the smart lid 10 to the trash cart 20. The lid attachment mechanism 160 may be adjustable to fit a wide variety of trash carts 20. For example, some trash carts 20 may be adapted to secure a smart lid 10 to hinge pins 210 while other trash carts 20 may be adapted to secure a smart lid 10 to a cart handle 215. The lid attachment mechanism 160 may be adapted to be secured to both hinge pins 210 and cart handles 215.

In an embodiment, shown in FIG. 4a, the smart lid 10 may include adjustable hinge caps 220 that may be independently adjusted to secure the smart lid 10 to trash carts 20 of various configurations. The hinge caps 220 may be adapted to attach to the smart lid 10 along an attachment face 230 of the smart lid 10.

As shown in FIG. 4b, the attachment face 230 may be a boss face having various attachment points 240, such as bolt holes 250, that may be placed to enable the smart lid 10 to attach to popular models of trash carts 20. Each hinge cap 220 may include two or more parts adapted to encompass the hinge pin 210 or cart handle 215 to attach the smart lid 10 to a trash cart 20 when installed. For example, the hinge caps 220 may include a top bracket half 270 and a bottom bracket half 280 having an opposing first groove 275 and second grove 285 that may be joined to form an aperture 265 encompassing the hinge pin 210 or cart handle 215. Further, to permit further attachment configurations, the attachment face 230 may include a channel 260 to accommodate the hinge pin 210. The hinge pin 210 may be secured in the channel 260 by attaching the hinge caps 220.

In another embodiment, shown in FIG. 5c, the lid attachment mechanism 160 may include mounting arms 170 including a hinge 180. The hinge 180 may include metal materials made of aluminum alloy or non-ferrous composite to prevent corrosion. In a preferred embodiment, the hinge 180 is a two-part hinge 180 wherein the first part 190 of the two-part hinge 180 is attached to the mounting arms 170. In the preferred embodiment, the second part 200 of the two-part hinge 180 may be chosen from a plurality of configurations corresponding to various trash and recycling cart hinge pins 210. For example, a second part 200 of the two-part hinge 180 may be adapted to encompass a hinge pin 210, or cart handle, of a particular diameter. In the embodiment shown, the mounting arms 170 are rigidly molded as a part of the body 140 of the smart lid 10. In other embodiments, the mounting arms 170 may be laterally adjustable to fit various cart configurations to be secured between structural elements of the hinge pin 210 or cart handle 215.

The advertising 50 may be provided as panels of placards 290 that may be made from weather resistant materials that will accept black and white or color printing (for example 4-color printing). Placards 290 may preferably be constructed to withstand usage in an outdoor context for up to 180 days. Placards 290 are easy to install, replace and serviced by field technicians. In a preferred embodiment, the placards 290 are configured to be readable at close range when in use (both when rolling the trash cart 20 and when opening and closing the smart lid 10 on the trash cart 10). The placards 290 may include QR codes imprinted on each placard 290 that may be easily scanned by a QR code reader, such as a mobile device, to provide additional information or promotions.

The smart lid 10 may include a sampling program dispenser 300 to provide consumers with promotional samples 310. It is contemplated that when consumers are taking out the trash they may be especially primed to receive promotional samples 310 for hygiene and sanitary related products, such as, hand sanitizer, dishwashing detergent, etc. Promotional samples 310 may be provided via a dispenser 300 integrated into the smart lid 10. The dispenser 300 may be configured to provide access to a service person, such as a trash hauler, to refill or replace the promotional samples 310.

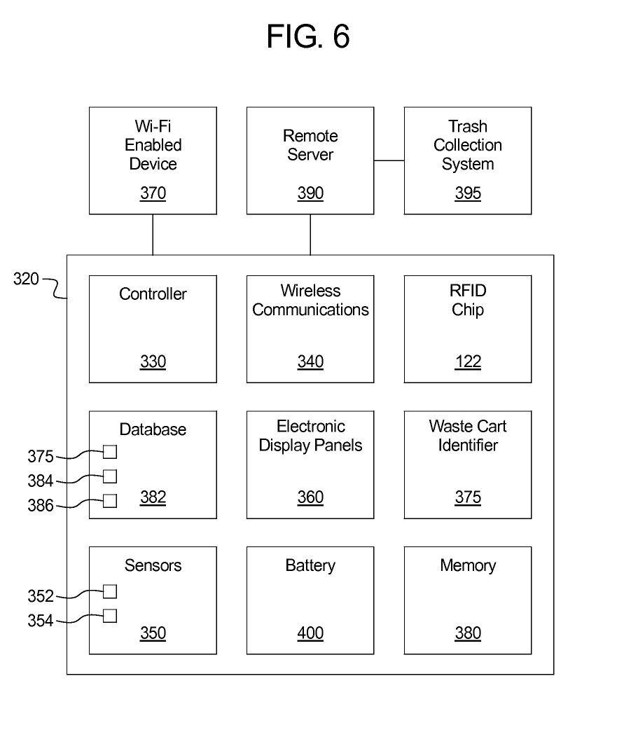

As shown in FIG. 6, the smart lid 10 may include a smart lid control subsystem 320 to provide additional services, manage electronic advertising, and to monitor the smart cart 10. For example, in an embodiment, the smart lid control subsystem 320 may be mounted in, formed within, attached to, or otherwise physically provided with the smart lid 10 and may include a controller 330, a memory 335 including instructions that may be executed by the controller 330, an database 382, wireless communications module 340, sensors 350, and digital display panels 360. In other embodiments, the smart lid control subsystem 320 may be a remote system that communicates with, and controls, the digital display panels 360 and the sensors 350 packaged with the smart lid 10. In some embodiments, aspects of the smart lid control subsystem 32 may be provided remotely by remote servers 390, for example, the database 382 may be provided by the remote servers 390.

The smart lid control subsystem 320 may be powered by a battery 370 or by an alternative power source, such as solar panels. The wireless communication module 340 may act as a repeater for cellular communications. Alternatively, or additionally, the wireless communications module 340 may provide a wireless access point for nearby consumers, for example, a Wi-Fi-enable device 370.

The smart lid control subsystem 320 may include functionality to control the display of advertising 50. For example, in an embodiment, the controller 330 selects an advertisement 50 from an advertising database 382 that stores a plurality of advertisements 50 and is in communication with the controller 330. The controller 330 then displays the selected advertisement 50 on at least one digital display panels 360. In other embodiments, the controller 330 may receive data from the at least one sensor 350, and select an advertisement 50 from the advertising database 382 using the received data from the sensor 350.

For example, in an embodiment, the controller 330 may receive data from a motion sensor 352 indicating movement of the body 140. Using the received data and an associated unique trash cart identifier 375, the controller 330 may then access the advertising database 382, select a different advertisement 50 from the database, and display the second advertisement 50 on the digital display panel 360. The advertising database 382 may include the unique trash cart identifier 375 and associated displayed first advertisement 50 in order to record advertising impressions 382 for use in targeting advertisements and measuring the reach of advertising 50. Further, the trash cart identifier 375 may be associated with demographic information of the household associated with the trash cart identifier 375, such as the age, gender, income, ethnicity, interests, affiliations, etc., of the household. Accordingly, when the smart lid 10 is opened or closed, the trash cart 20 may record an impression 384. The recorded impressions 384 may be transmitted to remote servers 390 to collect the advertising results of the advertising 50 provided.

Similarly, when sensors 350 detect an open smart lid 10, digital advertising 50 on the display panels 360 may turned on, or be changed, for example, a video may be played, or a new advertisement may be displayed.

The sensors 350 may be used to measure information concerning the quantity and the composition of the trash cart 20 for analytic review. The sensors 350 may include chemical sensors 350 to detect trash cart 20 contents based on the molecular composition of the trash. For example, the chemical sensors 350 may be an electronic nose, chemosensor, etc. Via the wireless communications module 340, the controller 330 may relay sensor readings of the contents of the trash cart 20 to trash haulers to permit actions, such as early pickup of trash in response to the detection of contents likely to attract pests, such as rodents and insects.

As another example, the sensors 350 may further detect how full the trash cart 20 is. In an embodiment, the controller 330 may receive data from a proximity sensor 354, wherein the received data includes a trash cart identifier 375 and an associated waste height data 386 of waste within the trash cart 20 associated with the trash cart identifier 375. The controller 330 may then store the received data in the database 382. The database 382 may include a plurality of trash cart identifiers 375 and associated waste heights. Upon receiving waste height data 386 indicating matches a predetermined waste height threshold, such as six inches, the controller 330 may communicate the waste height data 386 to a remote server 390 in communication with a trash collection system 395. Upon receiving data indicating the waste height matches the predetermined waste height threshold, the controller 330 may be configured to display a message on the display panel 40, such as a message indicating the trash cart 20 is full.

As described, a controller 330 controls aspects of the smart lid control subsystem 320 described herein. The controller 330 may be embodied in one or more controllers 330 that may be adapted run a variety of application programs, access and store data, including accessing and storing data in the associated database 382 (which may be embodied in one or more databases 382), and enable one or more interactions with the other components of the smart lid control subsystem 320. Typically, the one or more controllers 330 are embodied in one or more programmable data processing devices. The hardware elements, operating systems, and programming languages of such devices are conventional in nature, and it is presumed that those skilled in the art are adequately familiar therewith.

For example, the one or more controllers 330 may be a PC based implementation of a central control processing system utilizing a central processing unit (CPU), memories 380 and an interconnect bus. The CPU may contain a single microprocessor, or it may contain a plurality of microprocessors for configuring the CPU as a multi-processor system. The memories include a main memory 380, such as a dynamic random access memory 380 (DRAM) and cache, as well as a read only memory 380, such as a PROM, EPROM, FLASH-EPROM, or the like. The system may also include any form of volatile or non-volatile memory 380. In operation, the main memory stores at least portions of instructions for execution by the CPU and data for processing in accord with the executed instructions.

The one or more controllers 3300 may also include one or more input/output interfaces for communications with one or more processing systems. Although not shown, one or more such interfaces may enable communications via a network, e.g., to enable sending and receiving instructions electronically. The communication links may be wired or wireless.

The one or more controllers 330 may further include appropriate input/output ports for interconnection with one or more output displays and one or more input mechanisms serving as one or more user interfaces for the controller 330. For example, the one or more controllers 330 may include a graphics subsystem to drive the digital display panels 360. The links of the peripherals to the system may be wired connections or use wireless communications.

Although summarized above as a PC-type implementation, those skilled in the art will recognize that the one or more controllers 330 also encompasses systems such as host computers, servers, workstations, network terminals, and the like. In fact, the use of the term controller 330 is intended to represent a broad category of components that are well known in the art.

Aspects of the systems and methods provided herein encompass hardware and software for controlling the relevant functions. Software may take the form of code or executable instructions for causing a controller 330 or other programmable equipment to perform the relevant steps, where the code or instructions are carried by or otherwise embodied in a medium readable by the controller 330 or other machine. Instructions or code for implementing such operations may be in the form of computer instruction in any form (e.g., source code, object code, interpreted code, etc.) stored in or carried by any tangible readable medium.

As used herein, terms such as computer or machine “readable medium” refer to any medium that participates in providing instructions to a processor for execution. Such a medium may take many forms. Non-volatile storage media include, for example, optical or magnetic disks, such as any of the storage devices in any computer(s) shown in the drawings. Volatile storage media include dynamic memory 380, such as main memory 380 of such a computer platform. Common forms of computer-readable media therefore include for example: a floppy disk, a flexible disk, hard disk, magnetic tape, any other magnetic medium, a CD-ROM, DVD, any other optical medium, punch cards paper tape, any other physical medium with patterns of holes, a RAM, a PROM and EPROM, a FLASH-EPROM, any other memory chip or cartridge, or any other medium from which a computer can read programming code and/or data. Many of these forms of computer readable media may be involved in carrying one or more sequences of one or more instructions to a processor for execution.

It should be noted that various changes and modifications to the presently preferred embodiments described herein will be apparent to those skilled in the art. Such changes and modifications may be made without departing from the spirit and scope of the present invention and without diminishing its attendant advantages.

We claim:

1. A trash cart lid comprising:
a body including four edges, wherein the four edges define a perimeter of the body; and
at least one flange connected to the body, wherein the flange shares at least a portion of an edge of the body;
wherein each flange includes an advertising receiving space.

2. The trash cart lid of claim 1 wherein the advertising receiving space includes a slot to receive an advertisement placard.

3. The trash cart lid of claim 1 wherein the advertising receiving space is an electronic display.

4. The trash cart lid of claim 1 wherein the body includes a top surface and at least two advertising receiving spaces, wherein the advertising receiving space extend vertically from an edge of the body to the top surface.

5. The trash cart lid of claim 1 wherein the body includes a top surface and four side surfaces, wherein each side surface extends from an edge of the body to the top surface, wherein at least three side surfaces include an advertising receiving space.

6. The trash cart lid of claim 1 wherein the four edges are each separated by a corner, wherein the lid further includes at least one corner handle connected to at least one corner.

7. The trash cart lid of claim 1 wherein, when the trash cart lid is hingedly attached to a trash cart having a rim defining an opening into a cavity of the trash cart, each flange extends below a plane defined by the rim of the trash cart when the trash cart lid covers the opening of the trash cart.

8. The trash cart lid of claim 1 comprising three flanges, wherein each flange is attached to a separate edge of the body.

9. The trash cart lid of claim 1 further comprising:
an attachment face connected to at least one edge of the body of the lid; and
an adaptor configured to attach the trash cart lid to a trash cart, wherein the adaptor includes at least two hinge caps removably attached to the attachment face, wherein each hinge cap includes a first groove and a second groove, wherein the first groove and the second grove define an aperture to receive a cart handle of a trash cart.

10. A waste container lid comprising:
a body including four edges, wherein the four edges define a perimeter of the body;
at least one flange extending from the body, wherein the flange shares at least a portion of an edge of the body, wherein each flange includes an advertising receiving space, wherein at least one advertising receiving space includes a display panel;
a controller in communication with the display panel; and
a memory coupled to the controller, wherein the memory is configured to store program instructions executable by the controller, wherein in response to executing the program instructions, the controller is configured to:
select an advertisement from a database in communication with the controller, wherein the database includes a plurality of advertisements; and
display the selected advertisement on at least one display panel.

11. The trash cart lid of claim 10 further comprising at least one sensor in communication with the controller, wherein the controller is further configured to:
receive data from the at least one sensor, and
select an advertisement from the database, wherein the selected advertisement is based on the received data.

12. The trash cart lid of claim 10 further comprising at least one motion sensor in communication with the controller, wherein the controller is further configured to:
receive data from the motion sensor indicating movement of the body, wherein the received data is associated with a unique trash cart identifier;
access a database including the unique trash cart identifier and associated displayed first advertisement;
select a second advertisement from the database, wherein the first advertisement and second advertisement are different; and
display the second advertisement on the display panel.

13. The trash cart lid of claim 10 wherein the body includes a top surface and four side surfaces, wherein each side surface extends from an edge of the body to the top surface, wherein at least three side surfaces include an advertising receiving space.

14. The trash cart lid of claim 10 wherein the four edges are each separated by a corner, wherein the lid further includes at least one corner handle connected to at least one corner.

15. The trash cart lid of claim 10 wherein, when the trash cart lid is hingedly attached to a trash cart having a rim defining an opening into a cavity of the trash cart, each flange extends below a plane defined by the rim of the trash cart when the trash cart lid covers the opening of the trash cart.

16. The trash cart lid of claim 10 comprising three flanges, wherein each flange is attached to a separate edge of the body.

17. The trash cart lid of claim 10 further comprising:
an attachment face connected to at least one edge of the body of the lid; and
an adaptor configured to attach the trash cart lid to a trash cart, wherein the adaptor includes at least two hinge caps removably attached to the attachment face, wherein each hinge cap includes a first groove and a second groove, wherein the first groove and the second grove define an aperture to receive a cart handle of a trash cart.

18. The trash cart lid of claim 10 further comprising at least one proximity sensor in communication with the controller, wherein the controller is further configured to:
receive data from the proximity sensor, wherein the received data includes a trash cart identifier and an associated waste height of waste within the trash cart associated with the trash cart identifier;
store the received data in the database, wherein the database includes a plurality of trash cart identifiers and associated waste heights; and
upon receiving data indicating the waste height matches a predetermined waste height threshold, communicate the waste height data to a remote server in communication with a trash collection system.

19. The trash cart lid of claim 18 wherein, upon receiving data indicating the waste height matches the predetermined waste height threshold, the controller is configured to display a message on the display panel, wherein the message indicates the trash cart is full.
